(19) United States
(12) Patent Application Publication
(10) Pub. No.: US 2026/0249721 A1
(43) Pub. Date: Aug. 27, 2026

(54) CONCEALED LOCKING SYSTEM FOR ELECTRIC VEHICLE SUPPLY EQUIPMENT

(71) Applicant: Blink Network LLC, Bowie, MD (US)

(72) Inventors: Saurabh Ambre, Bowie, MD (US); Rajat Hegde, Bowie, MD (US); Chetan Banakar, Bowie, MD (US); Sanjay Honnal, Bowie, MD (US); Ghouse Mohammed, Bowie, MD (US)

(21) Appl. No.: 19/060,030

(22) Filed: Feb. 21, 2025

(51) Int. Cl. B60L 53/30; E05B 65/00; E05C 1/00

(52) U.S. Cl. CPC B60L 53/30; E05B 65/006; E05C 1/004

(57) ABSTRACT

An Electric Vehicle Supply Equipment (EVSE) unit includes a housing having an access panel configured to open and close, a charging holster integrated with the access panel, the charging holster configured for mating with a charging cable connector, a key cylinder behind the charging holster such that when the charging cable connector is holstered in the charging holster, the key cylinder is concealed, a movable element located behind the access panel, the element configured to engage and disengage with the housing so as to lock and unlock the access panel, a rack and pinion mechanism located in the housing, wherein the rack is operably connected to the element such that rotation of the pinion moves the element and wherein the key cylinder is operably connected to the pinion, such that rotation of a key within the key cylinder rotates the pinion.

### CROSS REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The technical field relates generally to Electric Vehicle Supply Equipment (EVSE) units, and more particularly, to access control systems for such units.

### BACKGROUND

Electric Vehicle Supply Equipment (EVSE) units have become increasingly prevalent as the demand for EVs continues to grow. These units are often installed in public or semi-public areas, making them vulnerable to vandalism, tampering, and unauthorized access. To ensure safety and functionality, EVSE units are designed with access panels that provide entry to internal components such as electrical wiring, control units, and power distribution systems. Securing these access panels is critical to prevent damage, theft, or hacking attempts that could compromise the unit's operation or pose safety risks to users.

Traditional EVSE units commonly employ visible locks to secure access panels. While these locks provide basic security, they are highly conspicuous, making them easy targets for vandals or individuals attempting to gain unauthorized access. Visible locks detract from the overall aesthetic of the unit and may invite tampering by signaling precisely where access can be gained. Once tampered with, these locks often become inoperable, leaving the internal components exposed and vulnerable.

Another challenge with conventional locking mechanisms is their limited resistance to environmental factors and physical stress. Locks positioned on the exterior of the unit are directly exposed to weather conditions, dirt, and debris, which can lead to corrosion, malfunction, or difficulty in operation over time. Furthermore, these locks often lack advanced tamper-resistant features, making them susceptible to unauthorized access using basic tools or force.

Other EVSE units feature bulky or industrial-looking locking mechanisms that detract from their visual appeal and fail to integrate seamlessly with modern urban environments. In addition, the design of some locks may inadvertently interfere with the unit's usability, such as impeding cable management systems or obstructing access to charging ports.

Therefore, a need exists to overcome the problems with the prior art as discussed above, and particularly for an improved method of securing access panels in EVSE units that provides enhanced security, resists tampering, and protects against environmental damage while maintaining a sleek, unobtrusive appearance.

### SUMMARY

A locking mechanism for an EVSE unit is provided. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, an Electric Vehicle Supply Equipment (EVSE) unit includes a housing having an access panel configured to open and close, a charging holster integrated with the access panel, the charging holster configured for mating with a charging cable connector, a key cylinder behind the charging holster such that when the charging cable connector is holstered in the charging holster, the key cylinder is concealed, a movable element located behind the access panel, the element configured to engage and disengage with the housing so as to lock and unlock the access panel, a rack and pinion mechanism located in the housing, wherein the rack is operably connected to the element such that rotation of the pinion moves the element and wherein the key cylinder is operably connected to the pinion, such that rotation of a key within the key cylinder rotates the pinion.

In another embodiment, an Electric Vehicle Supply Equipment (EVSE) unit includes a housing, an access panel configured to open and close, the access panel having at least a downwards facing surface, a movable element located behind the access panel, the element configured to engage and disengage with the housing so as to lock and unlock the access panel, a rack and pinion mechanism located in the housing, wherein the rack is operably connected to the element such that rotation of the pinion moves the element and a key cylinder located behind the downwards facing surface of the access panel, the key cylinder operably connected to the pinion, such that rotation of a key within the key cylinder rotates the pinion.

Additional aspects of the claimed subject matter will be set forth in part in the description which follows, and in part will be obvious from the description, or may be learned by practice of the claimed subject matter. The aspects of the claimed subject matter will be realized and attained by means of the elements and combinations particularly pointed out in the appended claims. It is to be understood that both the foregoing general description and the following detailed description are exemplary and explanatory only and are not restrictive of the disclosed subject matter, as claimed.

### BRIEF DESCRIPTION OF THE DRAWINGS

The accompanying drawings, which are incorporated in and constitute part of this specification, illustrate embodiments of the claimed subject matter and together with the description, serve to explain the principles of the claimed subject matter. The embodiments illustrated herein are presently preferred, it being understood, however, that the claimed subject matter is not limited to the precise arrangements and instrumentalities shown, wherein:

FIG. 1 is a front perspective view of an EVSE unit with the locking mechanism, in an open orientation, in accordance with a first embodiment.

FIG. 2 is a side perspective view of the EVSE unit with the locking mechanism, in an open orientation, in accordance with the first embodiment.

FIG. 3 is a front view of the charging holster and keyhole of the locking mechanism for the EVSE unit, in accordance with the first embodiment.

FIG. 4 is a rear view of the mechanical mechanism of the locking mechanism for the EVSE unit, in accordance with the first embodiment.

FIG. 5 is an exploded view of the locking mechanism for the EVSE unit, in accordance with the first embodiment.

FIG. 6 is a front perspective view of an EVSE unit with the locking mechanism, in a closed orientation, in accordance with a second embodiment.

FIG. 7 is a bottom perspective view of the EVSE unit with the locking mechanism, in a closed orientation, in accordance with the second embodiment.

FIG. 8 is a perspective closeup view of the EVSE unit with the locking mechanism, in an open orientation, in accordance with the second embodiment.

FIG. 9 is a perspective closeup view of the EVSE unit with the locking mechanism, in a closed orientation, in accordance with the second embodiment.

FIG. 10 is a bottom perspective closeup view of the EVSE unit with the locking mechanism, in an open orientation, in accordance with the second embodiment.

FIG. 11 is an exploded view of the EVSE unit with the locking mechanism, in accordance with the second embodiment.

FIG. 12 is a perspective view of an EVSE unit with the locking mechanism, in an open orientation, in accordance with a third embodiment.

FIG. 13 is a closeup view of the locking mechanism of the EVSE unit in an unlocked orientation, in accordance with the third embodiment.

FIG. 14 is a closeup view of the locking mechanism of the EVSE unit in a locked orientation, in accordance with the third embodiment.

FIG. 15 is a rear view of the locking mechanism of the EVSE unit, in accordance with the third embodiment.

FIG. 16 is a front view of the locking mechanism of the EVSE unit, in accordance with the third embodiment.

### DETAILED DESCRIPTION

The following detailed description refers to the accompanying drawings. Wherever possible, the same reference numbers are used in the drawings and the following description to refer to the same or similar elements. While embodiments of the claimed subject matter may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the claimed subject matter. Instead, the proper scope of the claimed subject matter is defined by the appended claims.

The claimed embodiments address the shortcomings of prior art EVSE unit locking mechanisms by providing a concealed locking system that enhances security, resists tampering, and improves the aesthetic appeal of the unit. By integrating the locking mechanism within the charging cable holster or beneath the lower edge of the access panel door, the claimed embodiments effectively hide the lock from view, making it difficult for vandals or unauthorized individuals to identify or access. This concealment not only deters tampering but also preserves the clean, modern appearance of the EVSE unit, aligning with the design expectations of contemporary urban environments.

The claimed embodiments'concealed design also protects the locking mechanism from direct exposure to environmental factors such as rain, dirt, and debris. By positioning the lock within the holster or beneath the panel, the mechanism is shielded from conditions that might otherwise cause corrosion or operational failures. This ensures greater durability and reliability over time, reducing maintenance costs and minimizing downtime for the EVSE unit.

In addition to enhancing security and durability, the claimed embodiments advance the state of the art by incorporating tamper-resistant fasteners, which require specialized tools to remove. This feature further prevents unauthorized access to the lock, adding an additional layer of protection against theft or vandalism. The use of concealed handles for secondary access panels also exemplifies the invention's thoughtful approach to security. These handles are only revealed once the primary access panel is opened, preventing external visibility, and ensuring strict control over access to internal components.

By addressing the vulnerabilities of visible locks while maintaining ease of use and visual harmony, the claimed embodiments represent a significant improvement over prior art locking mechanisms for EVSE units. The claimed embodiments not only resolve the security and aesthetic issues associated with conventional designs but also set a new standard for durability and user-centered functionality in EV infrastructure.

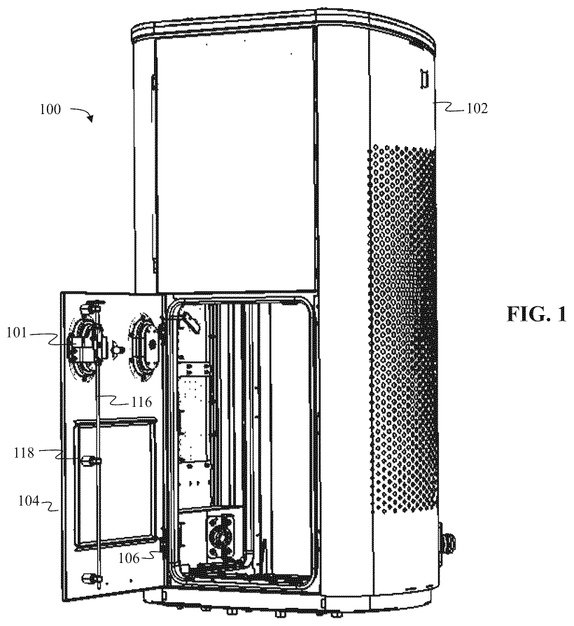

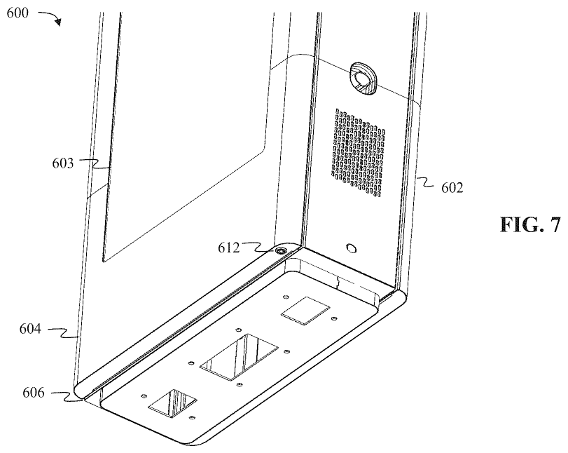

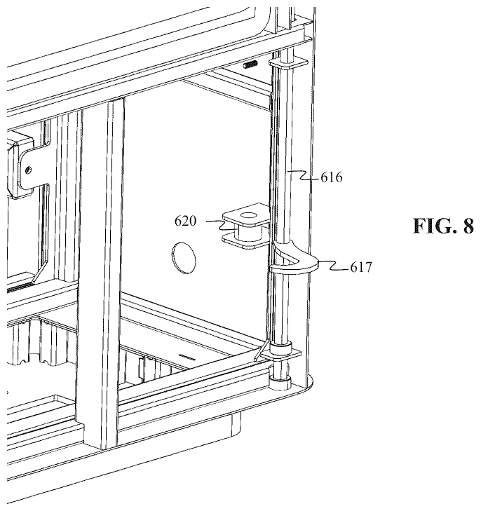

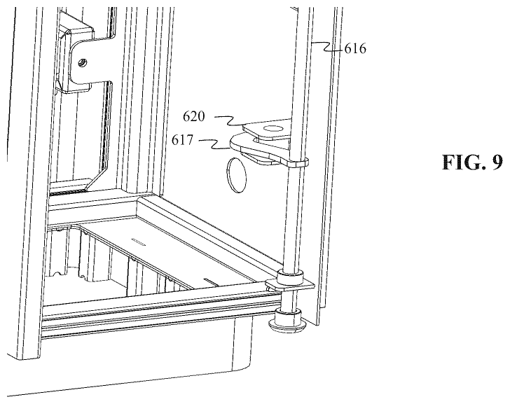

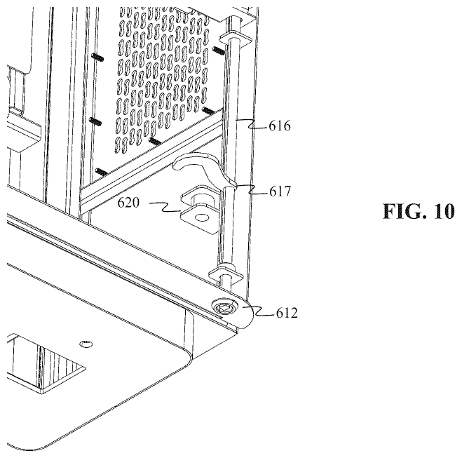

The accompanying drawings, which are incorporated in and constitute a part of this disclosure, illustrate various example embodiments. The claimed locking mechanism for an EVSE unit 100 will now be described with respect to FIGS. 1 through 16. The following detailed description refers to the accompanying figures, with item numbers included to illustrate the components of the embodiments of the locking mechanism for an EVSE unit.

FIG. 1 illustrates a front perspective view of the first embodiment of the EVSE unit 100 with the locking mechanism 101. The housing 102 forms the main structural component of the EVSE unit, enclosing internal electrical components and providing physical protection. The housing may be constructed from materials such as stainless steel, aluminum, or reinforced polymer to ensure durability and resistance to environmental factors. The access panel or door 104 is hinged using access panel hinges 106, allowing it to open and close for maintenance or inspection.

The mechanical mechanism 114, located behind the keyhole inside the housing, operates the vertical rod 116 to engage with holes 120 in the housing, securing the access panel in a locked position. The rod 116 may be made from stainless steel or high-strength alloys for robustness. The rod offsets 118 facilitate alignment with the holes 120 to ensure reliable locking. This view emphasizes the alignment of the vertical rod 116 with the holes 120 in the housing. The mechanical mechanism 114 includes internal components such as springs and gears, which are configured to retract the rod when activated by a key inserted into the keyhole. The materials used for the hinges, such as corrosion-resistant steel or anodized aluminum, ensure long-term performance under varying environmental conditions.

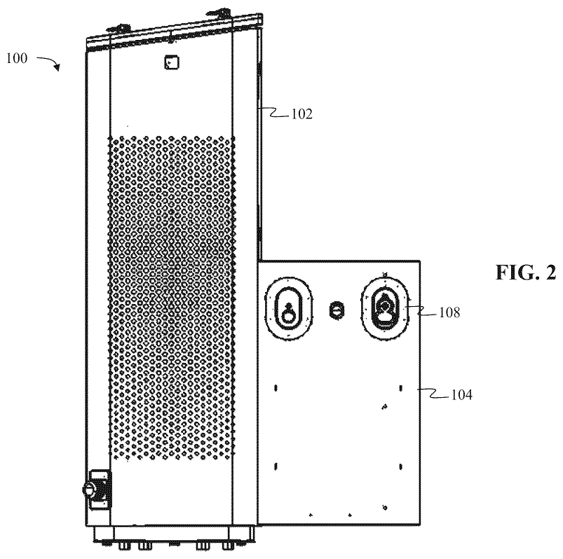

FIG. 2 presents a side perspective view of the EVSE unit 100, showing how the access panel or door 104 integrates with the housing 102. The hinges 106 allow the door to swing open when unlocked. The access panel includes a charging holster 108 located on its exterior surface. The charging holster is designed to securely hold a charging cable connector and includes a charging holster hood 110 that shields the holster and the concealed keyhole 112 from view when the charging cable connector is holstered. The keyhole 112 provides access to the internal locking mechanism and is concealed within the holster, improving both aesthetics and security. The keyhole 112 is positioned within the charging holster 108, and the hood 110 extends over the keyhole, providing protection from dirt and weather. Alternative materials for the holster and hood may include high-impact plastic or powder-coated aluminum to balance durability with weight considerations.

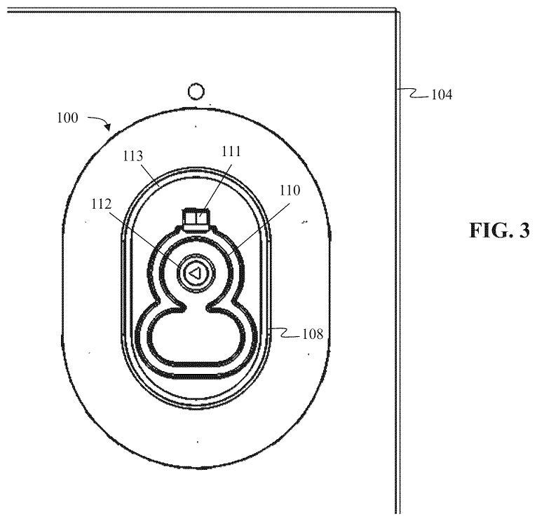

FIG. 3 depicts a close-up front view of the charging holster 108 and the keyhole 112. The holster includes contours to cradle the charging cable connector securely and is designed to obscure the keyhole when the connector is in place. The hood 110 further enhances concealment, minimizing visibility of the keyhole from common viewing angles. The keyhole is compatible with various key types, including tamper-resistant or electronic keys, offering flexibility in design. The holster may feature additional elements, such as an LED light diffuser, to improve usability in low-light conditions.

The charging holster 108 includes a hood or shroud 110 that extends over the holster, acting as a protective cover and concealment feature. The shroud may be constructed from durable materials such as high-impact plastic or anodized aluminum to provide resistance to physical damage, environmental exposure, and tampering. It extends outward and downward from the holster, creating an overhang that obscures the holster's keyhole from direct visibility, especially when viewed from above or head-on. This design makes it difficult for unauthorized individuals to locate and manipulate the locking mechanism. The shroud also shields the holster from rain, dirt, and debris, ensuring long-term functionality and reducing maintenance needs. In some embodiments, the shroud may be curved or angled to further deflect environmental elements, while alternative designs may include a retractable or movable shroud for added flexibility.

The charging holster 108 also includes a latching mechanism 111 designed to securely hold the charging cable connector in place when it is not in use. This latching mechanism may consist of a spring-loaded clasp, detent, or similar mechanism that engages with a mating surface or notch on the connector. When the connector is inserted into the holster, the latching mechanism clicks into place, preventing the connector from being accidentally dislodged or removed. The latching mechanism may be made of materials such as reinforced nylon, stainless steel, or other wear-resistant composites to withstand repeated use. This feature serves both to protect the connector from damage when not in use and to ensure that the holster remains closed, and the keyhole concealed. Some embodiments may include a release button or lever for easy disconnection of the connector.

The charging holster 108 may further include an LED light diffuser 113 integrated into its design, providing illumination for the user during low-light conditions. The diffuser may be made from frosted polycarbonate or similar translucent material that evenly distributes light emitted by embedded LEDs. Positioned strategically near the holster, the LEDs ensure the keyhole and connector interface are clearly visible. The diffuser softens the light to reduce glare and improve user comfort. The lighting system may be powered by the EVSE unit's main power source or include a dedicated battery backup. In advanced embodiments, the LEDs may be motion-activated or include dimming features to conserve energy.

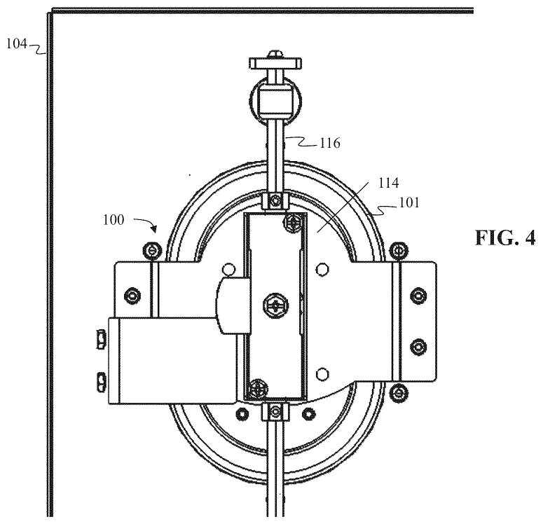

FIG. 4 shows a rear view of the mechanical mechanism 114. The mechanism is positioned on the rear of the access panel 104 and includes components such as a locking cam, spring-loaded pin, and gear assembly that interact with the vertical rod 116. When a key is inserted and rotated in the keyhole 112, the mechanical mechanism moves the rod into or out of engagement with the holes 120 in the housing. The use of precision-engineered gears ensures smooth operation, and alternative designs may include electrically actuated mechanisms powered by the EVSE unit's internal systems.

The mechanical mechanism 114 may be configured to activate when a key is inserted into the keyhole and rotated. The mechanism may include a cam or gear system that translates the rotational motion of the key into linear motion, moving the rod to engage or disengage from the housing holes. The mechanism ensures precise operation, with minimal resistance during activation. The keyhole 112 may be compatible with mechanical keys, electronic keys, or even biometric systems for added security. The mechanical components may be constructed from high-strength alloys, with options for sealed enclosures to protect against dirt and moisture. In some embodiments, the mechanism may be coupled with an electronic actuator to allow remote unlocking, providing additional flexibility for administrators or service personnel.

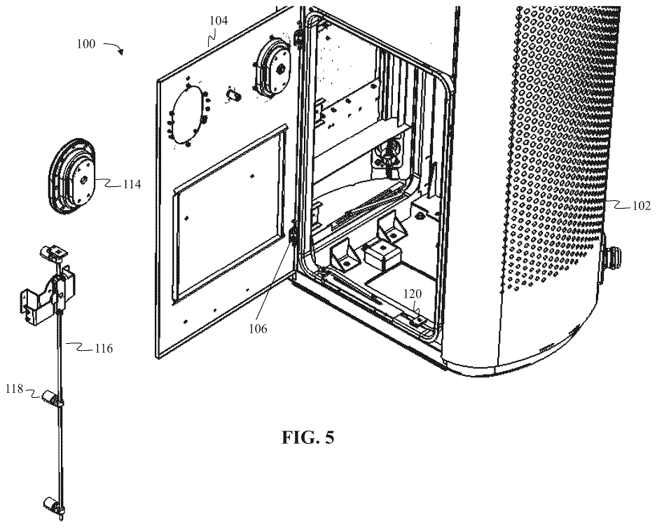

FIG. 5 provides an exploded view of the first embodiment of the locking mechanism for the EVSE unit 100. The components are shown separately, highlighting their assembly with the housing 102. The mechanical mechanism 114, vertical rod 116, and rod offsets 118 are depicted in relation to the holes 120, illustrating the locking system's internal configuration. This view demonstrates how the components interconnect and may be manufactured using modular techniques for ease of assembly and maintenance.

The rod 116 may include an end portion that is specifically shaped to conform to the geometry of the holes in the housing, ensuring a secure lock. This shaped end may take the form of a tapered or chamfered design, facilitating precise alignment during locking. The conforming shape provides a tight fit, which prevents rattling, reduces wear over time, and resists forceful tampering. For example, the end portion may be cylindrical, rectangular, or keyed to match the hole design. The rod itself may be constructed from materials such as hardened steel or titanium alloys to resist bending or breaking under stress. Alternative designs may include rubber or polymer coatings on the rod's end to dampen vibrations and further enhance the durability of the locking mechanism.

A spring mechanism may be configured to assist in retracting the rod from the holes during unlocking. This spring mechanism may consist of a coiled compression or torsion spring located within the mechanical mechanism. When the keyhole 112 is activated, either manually or electronically, the spring compresses and stores energy. Upon unlocking, the stored energy is released, smoothly retracting the rod out of the holes. The spring ensures consistent and reliable operation, even under varying environmental conditions. Materials for the spring include stainless steel or phosphor bronze, chosen for their corrosion resistance and high fatigue strength. In some embodiments, the spring mechanism may be adjustable to modify the retraction force, allowing for customization based on application needs.

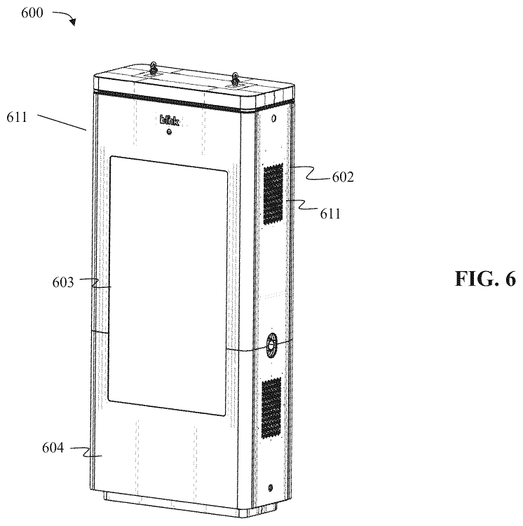

FIGS. 6 through 11 illustrate the second embodiment of the EVSE unit 600 and locking mechanism. The housing 602 and access panel 604 are similar to the first embodiment but include key differences in the location of the keyhole 612. The keyhole 612 is positioned on the downward-facing surface of the access panel, hidden from direct view. Hinges 606 allow the panel to open and close, while a mechanical mechanism operates the vertical rod 616 to engage with loops 620 in the housing. The rod hooks 617 provide a secure engagement with the loops, ensuring the panel remains locked until the mechanism is activated.

The access panel 604 integrates seamlessly with the housing 602, and the hinges 606 allow for smooth operation. The materials for the housing, such as powder-coated steel or weather-resistant alloys, provide durability and protection against tampering. The EVSE unit 600 may include a display panel 603 integrated into the housing, configured to provide user instructions and status information. This panel may be an LCD, OLED, or e-ink screen, offering a durable and energy-efficient solution. The display is designed to show information such as charging status, estimated charging time, instructions for use, and troubleshooting guidance. In some embodiments, the panel may include touchscreen functionality, allowing users to interact directly with the charger. The panel may be housed within a weatherproof enclosure and may include anti-glare coatings for readability in bright sunlight. Advanced versions may support remote updates or integrate with smartphone apps for enhanced functionality.

Note the placement of the keyhole 612 on the downward-facing surface of the access panel 604. The loops 620 in the housing align with the vertical rod 616 when the panel is closed. This configuration minimizes visibility and accessibility of the locking mechanism, enhancing security. The integration of the locking mechanism within the downward-facing surface ensures the keyhole 612 remains unobtrusive while providing easy access for authorized users.

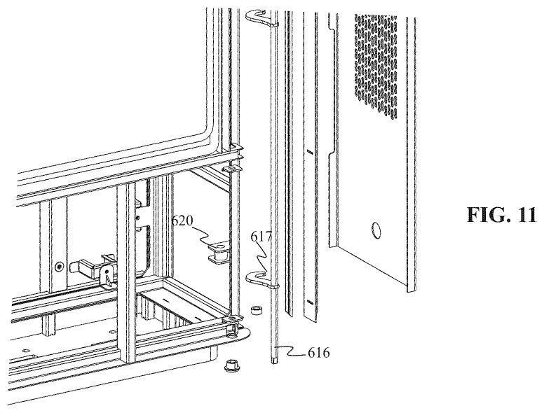

FIG. 11 provides an exploded view of the second embodiment of the locking mechanism for the EVSE unit 600. The housing 602, access panel 604, hinges 606, and mechanical mechanism are shown separately, illustrating their assembly. The vertical rod 616, rod hooks 617, and loops 620 are depicted in relation to one another, demonstrating how the locking mechanism engages to secure the access panel.

The access panel may incorporate an air filter 611 to remove particulates from air entering the housing. This filter may be made from multi-layer synthetic fiber or activated carbon material and is positioned over ventilation openings in the access panel. The filter protects internal electronic components from dust, dirt, and other airborne contaminants, improving the longevity and reliability of the EVSE unit. The air filter is designed for easy replacement and may include additional features, such as antimicrobial coatings or moisture resistance, to address specific environmental conditions. Alternative designs may include HEPA filters for high-efficiency particulate removal in regions with extreme air quality concerns.

A cable management system may be integrated with the housing 102 to guide and store the charging cable. This system may include retractable spools, guide channels, or flexible arms designed to organize the cable neatly when not in use. The system may also feature frictionless rollers or pulleys to minimize wear and ease cable movement. Constructed from materials such as reinforced nylon or powder-coated aluminum, the cable management system is designed to withstand outdoor conditions. This feature reduces clutter around the charger, improves safety by preventing tripping hazards, and enhances the overall user experience by making cable handling intuitive and effortless. Some systems may include automatic retraction mechanisms powered by the unit's main power source.

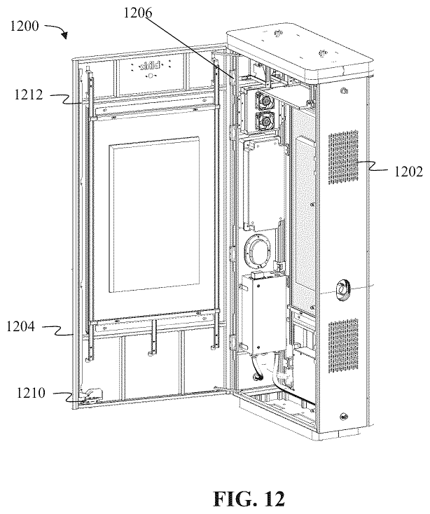

FIGS. 12 through 16 illustrate the third embodiment of the EVSE unit 1200 and locking mechanism 1210. FIG. 12 is a perspective view of the third embodiment of an EVSE unit 1200 in an open orientation. A housing 1202 encloses the internal electrical and mechanical systems, providing structural support. An access panel 1204 is connected to the housing 1202 via hinges 1206, permitting the panel to swing open for service or inspection. Within the lower portion of the housing 1202 is a locking mechanism 1210, which remains largely hidden from direct view when the access panel 1204 is closed.

Extending vertically inside the housing is a vertical bar 1212 (otherwise referred to as a movable element), which slides up or down to engage or disengage the access panel 1204. This vertical bar 1212 is operably coupled to a plate 1220 and a rack 1213, both of which respond to rotational input from a key cylinder 1225. The key cylinder 1225, oriented vertically within the locking mechanism 1210, is accessible only through the bottom-facing surface of the housing 1202 to deter tampering. When a key is inserted and turned, the key cylinder 1225 rotates a pinion 1214 that moves the rack 1213 laterally, in turn moving the plate 1220 and causing the vertical bar 1212 to shift between locked and unlocked positions.

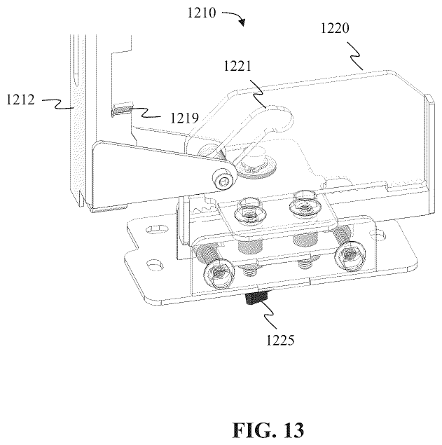

FIG. 13 provides a closeup view of the locking mechanism 1210 in an unlocked orientation. Here, the key cylinder 1225 is shown at the lowest portion of the assembly, extending upward inside the locking mechanism 1210. The pinion 1214 is fixed to the top end of the key cylinder 1225—as the key cylinder 1225 rotates, the pinion 1214 likewise rotates.

Mating with the pinion 1214 is the rack 1213, which translates pinion rotation into lateral motion. Attached to the rack 1213 is the plate 1220, which lies in a plane generally perpendicular to the vertical axis defined by the key cylinder 1225. Within the plate 1220 is a cutout 1221—a slot or channel through which a protrusion 1239 on the vertical bar 1212 travels. In the unlocked orientation, the plate 1220 and its cutout 1221 have shifted in such a way that the vertical bar 1212 rests in a lowered position, freeing the access panel 1204 so that it may be opened.

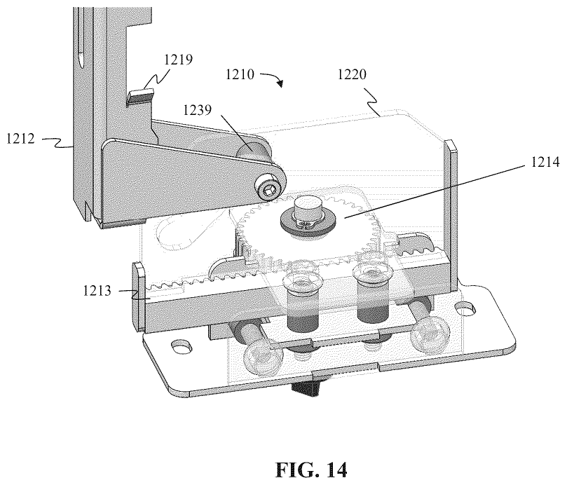

FIG. 14 illustrates the same locking mechanism 1210 in a locked orientation. In this locked state, the key cylinder 1225 has been rotated to drive the pinion 1214, moving the rack 1213 and plate 1220 laterally. As a result, the protrusion 1239 on the vertical bar 1212 is driven upward within the cutout 1221. The upward travel of the vertical bar 1212 causes a protuberance (or hook) 1219 formed on the upper portion of the vertical bar 1212 to catch securely on a loop or receptacle inside the housing 1202.

Once the protuberance 1219 of the vertical bar 1212 engages the loop in the housing 1202, the access panel 1204 cannot be pulled open, thereby locking the EVSE unit 1200. This configuration conceals most of the locking components behind the access panel 1204 and within the housing 1202, shielding them from direct exposure to environmental conditions, debris, and potential tampering tools.

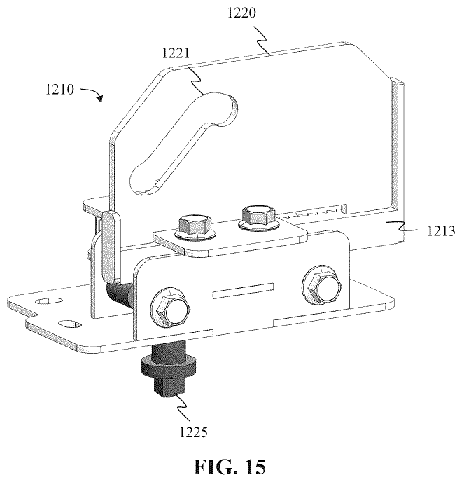

FIG. 15 is a rear view of the locking mechanism 1210, further emphasizing how each element interfaces at the back side of the access panel 1204. From this perspective, one can see the plate 1220 and rack 1213 are shown. The cutout 1221 in the plate 1220 appears in alignment with the vertical bar 1212's protrusion, which interlocks with the plate's movement. By placing these key mechanical parts behind the panel and within the enclosed housing 1202, the design reduces external access to crucial locking points, providing added security and weather resistance.

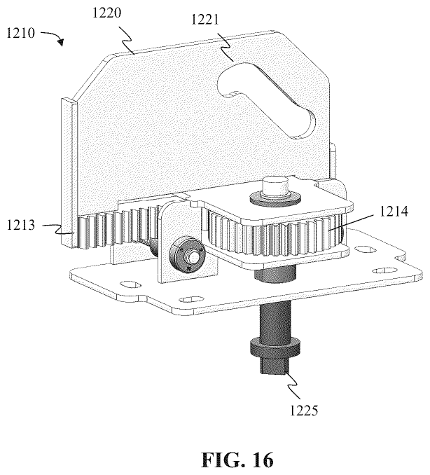

FIG. 16 is a front view of the locking mechanism 1210. Here, the key cylinder 1225 is seen at the bottom portion of the mechanism, where a user's key would be inserted through the underside of the housing 1202. The vertical alignment of the key cylinder 1225 allows the cylinder's longitudinal axis to be substantially colinear with that of the pinion 1214, simplifying the rack-and-pinion assembly.

In this front view, the rack 1213 spans horizontally, and the pinion 1214 meshes with its teeth. The plate 1220 is attached to or integrated with the rack 1213, so the two move in unison. The path defined by the cutout 1221 in the plate 1220 channels the vertical bar 1212 to travel up or down as dictated by the rotation of the pinion 1214. This mechanical linkage ensures a smooth transition between the locked and unlocked states and keeps the locking motion simple and robust, minimizing the possibility of jamming or misalignment over time.

By integrating the locking mechanism 1210 behind the access panel 1204 and making the keyhole accessible only from the bottom-facing portion of the housing 1202, the third embodiment maximizes security and reduces vulnerability to prying, cutting tools, or weather-related damage. This concealed approach also maintains a sleek external appearance, preserving the aesthetic qualities demanded by modern urban infrastructure.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An Electric Vehicle Supply Equipment (EVSE) unit, comprising:
a. a housing having an access panel configured to open and close;
b. a charging holster integrated with the access panel, the charging holster configured for mating with a charging cable connector;
c. a key cylinder behind the charging holster such that when the charging cable connector is holstered in the charging holster, the key cylinder is concealed;
d. a movable element located behind the access panel, the element configured to engage and disengage with the housing so as to lock and unlock the access panel;
e. a rack and pinion mechanism located in the housing, wherein the rack is operably connected to the element such that rotation of the pinion moves the element; and
f. wherein the key cylinder is operably connected to the pinion, such that rotation of a key within the key cylinder rotates the pinion.

2. The EVSE unit of claim 1, wherein the charging cable holster includes an LED light diffuser configured to provide illumination for improved usability.

3. The EVSE unit of claim 1, wherein the housing includes a projection adjacent to the element and wherein the element includes a protrusion configured to engage with the projection of the housing so as to lock the access panel.

4. The EVSE unit of claim 3, wherein the rack and pinion mechanism further includes a plate operably connected to the rack such that rotation of the pinion moves the plate, and wherein the plate is operably connected to the element such that movement of the plate moves the element.

5. The EVSE unit of claim 4, wherein the key cylinder is coupled to the pinion, such that the longitudinal axis of the key cylinder is colinear with the longitudinal axis of the pinion.

6. The EVSE unit of claim 5, wherein the plate moves in a plane that is perpendicular to the longitudinal axis of the key cylinder and the pinion.

7. An Electric Vehicle Supply Equipment (EVSE) unit, comprising:
a. a housing;
b. an access panel of the housing configured to open and close, the access panel having at least a downwards facing surface;
c. a movable element located behind the access panel, the element configured to engage and disengage with the housing so as to lock and unlock the access panel;
d. a rack and pinion mechanism located in the housing, wherein the rack is operably connected to the element such that rotation of the pinion moves the element;
e. a key cylinder located behind the downwards facing surface of the access panel, the key cylinder operably connected to the pinion, such that rotation of a key within the key cylinder rotates the pinion.

8. The EVSE unit of claim 7, wherein the housing includes a projection adjacent to the element and wherein the element includes a protrusion configured to engage with the projection of the housing so as to lock the access panel.

9. The EVSE unit of claim 8, wherein the rack and pinion mechanism further includes a plate operably connected to the rack such that rotation of the pinion moves the plate, and wherein the plate is operably connected to the element such that movement of the plate moves the element.

10. The EVSE unit of claim 9, wherein the key cylinder is coupled to the pinion, such that the longitudinal axis of the key cylinder is colinear with the longitudinal axis of the pinion.

11. The EVSE unit of claim 10, wherein the plate moves in a plane that is perpendicular to the longitudinal axis of the key cylinder and the pinion.
